(19) United States
(12) Patent Application Publication
(10) Pub. No.: US 2005/0107039 A1
(43) Pub. Date: May 19, 2005

(54) Co-channel interference detector for cellular communications systems

(76) Inventors: Bengt Lindoff, Bjarred (SE); Frerik Nordstrom, Lund (SE); Jan Holst, Dalby (SE)

Correspondence Address: JENKENS & GILCHRIST, PC, 1445 ROSS AVENUE, SUITE 3200, DALLAS, TX, 75202, US

(21) Appl. No.: 10/495,095

(22) PCT Filed: Oct. 8, 2002
(86) PCT No.: PCT/EP02/11269

Related U.S. Application Data
(60) Provisional application No. 60/336,078, filed on Nov. 14, 2001.

(30) Foreign Application Priority Data
Nov. 9, 2001 (EP) 01610113.1

(51) Int. Cl. H04B 1/00

(52) U.S. Cl. 455/63.1

(57) ABSTRACT

The invention offers a method of estimating the channel parameters of a co-channel interferer. Initial, rough estimates of the desired channel and of the desired data symbols are made, and a fraction of the estimated desired signal is subtracted from the received signal. The fraction depends on the uncertainty of the desired signal. The synchronisation position of the co-channel interferer is determined, which is used to reject the co-channel interference. In a pre-processing stage only rough estimates of the desired transmission channel and of the desired data symbols are needed. Consequently, a much faster convergence of the algorithm used for detecting the co-channel interference results. When the co-channel interference signal has been detected, it can be eliminated by any suitable method.

### TECHNICAL FIELD OF THE INVENTION

This invention relates to a method and a mobile station for detecting co-channel interference (CCI) in a wireless cellular communications system including at least two base stations using the same frequency, and to a mobile radio station such as a mobile communications device or a mobile telephone for use in such a communications system. The invention will be useful in TDMA and FDMA systems such as GSM and IS-136.

### TECHNICAL BACKGROUND OF THE INVENTION

In cellular wireless communications systems each base station covers a geographical area called a cell. Neighbouring cells usually use different frequencies. Frequencies can be reused in different cells, and cells using the same frequency are usually separated geographically by at least one intermediate cell using a different frequency. A mobile telephone or other mobile communications device in one cell, called the home cell, will normally be served by the base station, called the home base station, in the home cell. For two cells using the same frequency their mutual geographical distance may not always give sufficient attenuation of their signals to ensure that their signals do not interfere with each other, especially for areas with intense mobile communication, where, for capacity reasons, frequencies need to be re-used. Consequently, it may happen that, at some locations in the home cell, the mobile telephone can receive signals from a remote base station in a remote cell using the same frequency. The remote base station handles information or traffic, which is unrelated to the information or traffic handled by the home base station. When signals from two unrelated base stations using the same frequency are received by a mobile telephone, the signals from the remote base station may disturb or interfere with the signals received from the home base station. This is an undesired phenomenon called co-channel interference (CCI), and the remote base station is called a co-channel interferer.

The use of mobile communication has increased significantly resulting in an increasing density of mobile stations such as mobile phones, in particular in metropolitan areas. In order to increase the capacity in modern Time Division Multiple Access (TDMA) cellular systems, such as Global System for Mobile Communication (GSM) or Enhanced Data rate for GSM Evolutions (EDGE), the density of base stations are increased correspondingly, and the cells are proportionally reduced in size. Hereby remote base stations using the same frequency as the home base station are placed closer to the home cell, which may increase the problem of co-channel interference. The capacity will thus be limited by interference phenomena and not by the sensitivity of the system, because near co-channel interferers will dominate the noise figure (i.e., the amount of undesired signal added in a received signal by the environment). Therefore, a significant portion of the noise received by a receiver will not be due to random noise but will be caused by co-channel interference. However, when designing a conventional receiver for a TDMA system, for instance in a mobile phone, the disturbance is often modelled as white noise. Thus, conventional receiver design is optimized for the sensitivity limited case and not for the interference limited case.

Suppression of co-channel interference requires knowledge of the desired channel, ie the transmissions from the home base station, and of the interfering co-channel for the co-channel interference suppression to be efficient. The mobile station knows the characteristics of the home channel, but in most cases the interfering co-channel is unknown, and its characteristics will therefore have to be estimated. Relevant transmission channel characteristics include in particular the channel impulse response and the relative time difference between the desired signal from the home base station and the signal from the interfering co-channel. The impulse response is the received signal that would result from a short impulse being transmitted from the transmitter.

In general, in the state of the art systems for interference suppression, co-channel interferers are demodulated or estimated using an equaliser, and estimated interference symbols are subtracted from the received symbols, whereby, in principle, only desired symbols remain. Co-channel interferers can be demodulated or estimated in several known ways. After the interference symbols have been subtracted from the received symbols, the remaining symbols are demodulated to extract the useful information from each burst or unit of transmitted signal.

FIG. 2 shows a simplified block diagram of a conventional TDMA receiver. In the front-end receiver the received signal is down-converted, filtered, A/D converted and sampled at a symbol rate. Mathematically, the output from the front-end receiver can be written as

$${y}_{t} = {\sum }_{k = 0}^{L} {h}_{k} {u}_{t - k} + {e}_{t} = {H}^{T} {U}_{t} + {e}_{t} \qquad ( 1 )$$

where
H^{T}=[h₀, . . . , h_{L}]^{T} is a complex-valued vector representing the radio channel of the home cell, ie the desired channel,
Uₜ=[uₜ, . . . , u_{t-L}]^{T} is a complex-valued vector representing the transmitted symbols in the home cell, eg 8-Phase Shift Keying (8-PSK), and
eₜ is noise, which is often assumed to be random or white noise.

A received burst contains a known symbol pattern, also known as a training sequence, which is recognised as such in the receiver. From the front-end receiver a received burst is fed to a synchronization and channel estimator that correlates the received burst with the known training sequence in order to find the synchronization position, ie the position within the received burst at which the training sequence starts. After the synchronization position is determined, channel estimation is performed in order to estimate the radio channel parameters Ĥ. Standard estimation techniques well known in the art, such as Least Squares and the like, can be used to obtain the channel estimate. The received burst, the estimated channel parameters Ĥ and the synchronization position are then fed to an equalizer that detects the transmitted symbols. Conceptually, the equalizer tries to find the symbols minimizing the following:

$${\hat{u}}_{j} = arg {min}_{u ∈ S} {\sum }_{t = 1}^{N} {\vert {y}_{t} - {\sum }_{k = 0}^{L} {\hat{h}}_{k} {u}_{t - k} \vert}^{2} , 1 \leq j \leq N \qquad ( 2 )$$

where S represents the symbol constellation (ie, the set of symbols define for the given type of modulation, such as 8-PSK). The output from the equalizer is the decided hard symbol, the residuals given as:

$${\hat{ɛ}}_{t} = {y}_{t} - {\sum }_{k = 0}^{L} {\hat{h}}_{k} {\hat{u}}_{t - k}$$

and a soft value, representing the uncertainty of the symbol estimate. The above described systems are well known in the art, see [1].

In a communications system where the receive or downlink frequency is reused in two or more cells the frequency reuse may introduce interfering signals or noise in the serving cell or home cell from the remote base station in a neighbouring or remote cell using the same frequency. As a result the signals received by the mobile station in the home cell will contain information from other base stations as well as noise. In a scenario with co channel interference, and in particular where the cells are small, and co-channel interferers are close to the home base station, the random noise will be dominated by the co-channel interference, and the noise et can no longer be assumed to be white noise. Assuming that there is one dominant co-channel interferer, a better model of the received signal is

$${y}_{t} = {\sum }_{k = 0}^{L} {h}_{k} {u}_{t - k} + {\sum }_{k = 0}^{L} {g}_{k} {v}_{t - k} = {H}^{T} {U}_{t} + {G}^{T} {V}_{t} + {e}_{t} \qquad ( 3 )$$

where
G^{T}=[g₀, . . . , g_{L}]^{T} is a complex-valued vector representing the radio channel for the CCI,
Vₜ=[vₜ, . . . , v_{t-L}]^{T} is a complex-valued vector representing the transmitted symbols of the CCI, and
eₜ is the noise, which is here assumed to be much smaller than the CCI signal.

The desired signal from the home base station and the CCI signal cannot be expected to be in synchronism, ie the bursts do not arrive at the same time at the receiver antenna (see FIG. 3), different techniques for rejecting the CCI signal, depending on the relative timing of the desired signal and the CCI signal. Good rejection of the CCI signal requires a correspondingly good estimate of the relative timing, or the synchronisation (short: sync.) position of the CCI signal. Further, the training sequence used by the CCI also needs to be found, since it in most cases is unknown. Thus there is a need for an efficient method of detecting co-channel interference by estimating the channel parameters, and in particular the synchronisation position and the training sequence, of a potential co-channel interferer. This will form the basis of cancelling the co-channel interference, whereby performance of the communications system will be improved.

It is the object of the invention to provide a co-channel interference detector that is faster and more efficient than the prior art co-channel interference detectors.

### SUMMARY OF THE INVENTION

The invention offers a method of estimating the channel parameters, and in particular the synchronisation position and the training sequence, of a co-channel interferer in a TDMA communications system such as the GSM system and the EDGE system. First, initial estimates of the home cell radio channel, ie the desired channel, and of the data symbols of the desired channel are made. Then, a fraction of the estimated desired signal is subtracted from the received signal, whereby a residual signal is created. The fraction depends on the uncertainty of the desired signal. Then, a correlation is performed between the residual signal and all possible training sequences, and the synchronisation position of the co-channel interferer is obtained. The thus obtained synchronisation information is then used in any suitable co-channel interference rejection algorithm, which is not part of the invention.

In a pre-processing stage only rough estimates of the desired transmission channel and of the desired data symbols are needed. A fraction of the roughly estimated desired data symbols is subtracted from the received signal whereby a more “clean” co-channel interference signal is obtained. Consequently, a much faster convergence of the algorithm used for detecting the co-channel interference results. When the co-channel interference signal has been detected, it can be eliminated by any suitable method.

### BRIEF DESCRIPTION OF THE DRAWINGS

FIG. 1 shows the cell structure of a FDMA wireless communications system,

FIG. 2 shows schematically a prior art TDMA receiver structure,

FIG. 3 shows schematically the relative timing of a received desired signal and a received co-channel interfering signal, and

FIG. 4 shows a preferred embodiment of the invention.

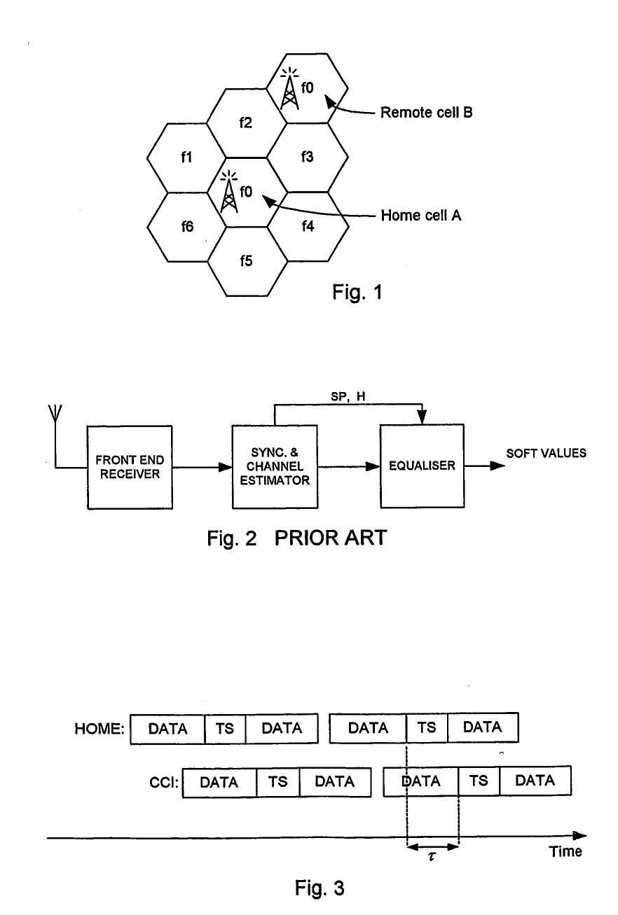

### DETAILED DESCRIPTION OF THE INVENTION

FIG. 1 shows a home cell A in which the home base station uses the frequency f₀. A number of neighbouring cells (in this case six are shown) cover the geographical area around the home cell A, and the base stations in neighbouring cells use different frequencies f₁ to f₆, all of which in particular are also different from the frequency f₀ used in the home cell A Further away from the home cell A and beyond the surrounding neighbouring cells is a remote cell B in which the remote base station uses the same frequency f₀ as is used in the home cell A. This is called frequency reuse. The remote base station in the remote cell B may thus cause co-channel interference to mobile stations in the home cell A

FIG. 3 shows a received desired signal from the home base station and a received interfering signal CCI from a remote base station. Each signal consists of a series of bursts, where each burst contains two data sequences with a training sequence TS between the two data sequences. The time difference between the two signals, which is also called the synchronisation position, is indicated as the time interval X between the start of their respective training sequences.

Transmitted data are divided into bursts or short packets of data. Each burst includes a training sequence, which is a predefined sequence of bits occupying a predefined position in each burst. In the receiver the training sequence will be recognised as such and will be used as a synchronising signal identifying eg the start and stop positions of each burst. Base stations using the same transmit frequency use different training sequences. In addition to using different transmission frequencies neighbouring base stations may also use different training sequences.

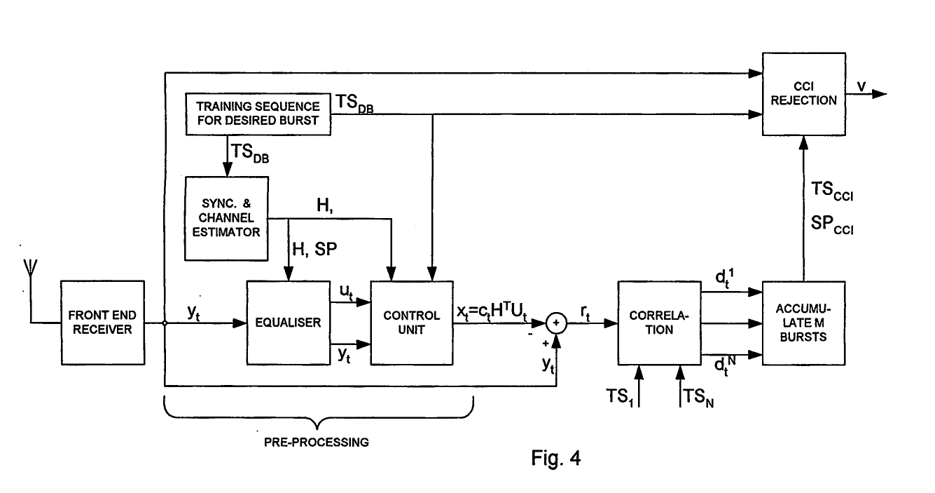

In FIG. 4 is shown a block diagram of the co-channel detection of the invention. In a front-end receiver received bursts are down-converted, filtered, A/D converted and sampled at a symbol rate. The received signal is assumed to be a combination of the desired signal and an undesired signal from a co-channel interferer, and, in accordance with the above, the output signal yt from the front-end receiver can thus be written mathematically as follows:

$${y}_{t} = {\sum }_{k = 0}^{L} {h}_{k} {u}_{t - k} + {\sum }_{k = 0}^{L} {g}_{k} {v}_{t - k} = {H}^{T} {U}_{t} + {G}^{T} {V}_{t} + {e}_{t} \qquad ( 3 )$$

where
H^{T}=[h₀, . . . , h_{L}]^{T} is a complex-valued vector representing the radio channel of the home cell, ie the desired channel,
Uₜ=[uₜ, . . . , u_{t-L}]^{T} is a complex-valued vector representing the transmitted symbols in the home cell,
G^{T}=[g₀, . . . , g_{L}]^{T} is a complex-valued vector representing the radio channel for the CCI,
Vₜ=[vₜ, . . . , v_{t-L}]^{T} is a complex-valued vector representing the transmitted symbols of the CCI, and
eₜ is noise, which is often assumed to be white noise.

From the front-end receiver bursts are fed to a pre-processing stage, whose main task is to give a rough estimate of the desired signal and to subtract a fraction of the estimated desired signal from the received signal. The residual signal resulting from the subtraction will be examined with respect to CCI.

The pre-processing stage includes a synchronisation and channel estimator, which performs an initial and possibly just a rough estimate Ĥ of the desired radio channel. For performing this estimate the estimator uses the received burst and the training sequence TS_{DB} of the desired burst, which is known. Preferably, also an estimate \hat{σ}ₛ² of the CCI noise is made using any suitable method known in the art such as the least squares method. The channel estimates Ĥ, the synchronisation position SP and the received burst yₜ are fed to the equaliser, which makes an initial detection of the desired data symbols û. Only a rough estimate of the data symbols is needed, and the equaliser can therefore be of low complexity such as DFE. The estimated symbols û, the CCI noise estimate \hat{σ}ₛ², the channel estimates Ĥ of the desired channel and the training sequence TS_{DB} of the desired burst are input to a control unit. Based on these inputs the control unit computes a time-dependent weighting factor cₜ, where 0<cₜ≦1, to be used for computing the residual signal rₜ. The control unit outputs a signal xₜ, which is an estimate of the desired channel Ĥ^{T}Ûₜ, which consists of both estimated symbols û and an estimate Ĥ of the channel, multiplied by the weighting factor cₜ according to the following formula:
xₜ=cₜĤ^{T}Û (4)

After the pre-processing stage the residual signal rₜ is calculated according to the following formula:
rₜ=yₜ−xₜ (5)

The residual signal rₜ is fed to a correlation unit that correlates the residual signal rt with all possible training sequences TS₁-TS_{N} for the undesired signal. The mobile receiving station knows these training sequences. In GSM/EDGE, eight training sequences are used. The correlation results d_{t,l}ⁱ for TSᵢ at time offset t for burst l are fed to an accumulation unit that accumulates the results over M bursts. The estimated training sequence TS_{CCI} and estimated synchronisation position SP_{CCI} are taken as the best match according to the following formula:

$$( {\hat{TS}}_{CCI} , {\hat{SP}}_{CCI} ) = arg {max}_{t , i} ( {\sum }_{l = 1}^{M} {\vert {d}_{t , l}^{i} \vert}^{2} ) \qquad ( 6 )$$

which are fed to a co-channel interference rejection unit, which can be of any suitable type, and which is not part of the invention.

Theoretical considerations and experiments have shown that a much better synchronisation performance for the co-channel interferer can be obtained by subtracting only a fraction cₜ, 0<cₜ≦1, of the estimated desired signal from the received signal before the CCI detection is performed, rather than subtracting the entire estimated desired signal as is done conventionally. The fraction cₜ depends on the uncertainty of the estimate of the desired signal, ie on the noise received together with the signal. Therefore, preferably also the noise is estimated, \hat{σ}_{g}². The control unit chooses the weighting factor cₜ depending on the noise and the uncertainty of the estimates of the channel parameters and the received symbols. Thus, if the uncertainty of the estimate of the desired signal is low, a value of cₜ close to, or possibly equal to, 1 is chosen, and if the uncertainty is high, a lower value is chosen.

The weighting factor cₜ can be varied not only with changing channel and reception quality but also over each burst. The training sequence of the desired bursts is known, since ûₜ=uₜ^{TS}, and during the training sequence a value of cₜ close to 1, or possibly equal to 1, is chosen. During the data sequences of each burst the uncertainty of the estimate of the signal is often higher, and a correspondingly lower value of cₜ is chosen, typically 0.6-0.7, but lower or higher values may also be used. Note that if the channel and the data symbols are known completely, then the optimal value is cₜ=1, ie the entire desired signal is subtracted, whereby the residual signal rₜ is the co-channel interference signal. In such cases the co-channel interference signal can then be determined completely and thus also eliminated completely.

### REFERENCE

[1] J. Proakis, Digital Communications, McGraw-Hill Inc., New York, 1995.

1. A method of detecting co-channel interference (CCI) in a mobile station when used in a wireless cellular communications system including at least a home cell (A) with a home base station using a transmit frequency (f₀), and a remote cell (B) with a remote base station using the same transmit frequency (f₀), the method comprising the following steps:
receiving a signal (yₜ) with bursts of desired symbols (U) transmitted by the home base station (A) through a home channel with home channel parameters (H),
setting a receive frequency of the mobile station to the transmit frequency (f₀) of the home base station, and, if a signal (yₜ) with bursts of undesired symbols (V) transmitted by the remote base station (B) is received through a co-channel with co-channel parameters (G), performing the following steps:
determining a synchronisation position of the signal received from the home base station,
estimating channel parameters (Ĥ) of the home channel,
estimating symbols (û) transmitted by the home base station, and
multiplying the estimated symbols (û) transmitted by the home base station by a weighting factor cₜ, 0<cₜ≦1, to obtain weighted estimated symbols (xₜ),
subtracting the weighted estimated symbols (xₜ) from the received signals (yₜ) to obtain a residual signal (rₜ), and
estimating, using the received signal (yₜ) and the residual signal (rₜ), a synchronisation position (SP_{CCI}) and a training sequence (TS_{CCI}) of bursts transmitted by the remote base station (B).

2. A method according to claim 1, further comprising the step of
correlating the residual signal (rₜ) with possible training sequences (TS₁-TS_{N}) for the bursts of undesired symbols (V).

3. A method according to claim 3, further comprising the step of
accumulating correlation results (d_{i,l}ⁱ) over a predetermined plurality (M) of bursts.

4. A method according to claim 3, wherein the estimated synchronisation position (SP_{CCI}) and the estimated training sequence (TS_{CCI}) of bursts transmitted by the remote base station (B) are taken as the best match according to the formula
$$( {\hat{TS}}_{CCI} , {\hat{SP}}_{CCI} ) = arg {max}_{t , i} ( {\sum }_{l = 1}^{M} {\vert {d}_{t , l}^{i} \vert}^{2} ) .$$

5. The method according to any one of claims 1-4, further comprising the step of
rejecting bursts of undesired symbols (V).

6. A method according to any one of claims 1-5, further comprising the steps of
estimating noise (\hat{σ}_{g}²) received with the signal (yₜ), and
generating the weighting factor (cₜ) in dependence on estimated channel parameters (Ĥ), on the estimated noise (\hat{σ}_{g}²), and on estimated symbols (û).

7. A method according to claim 6, wherein the weighting factor (cₜ) is generated in dependence on the estimated noise (\hat{σ}_{g}²), and on individual estimated symbols (û) in a burst.

8. A mobile station for use in a wireless cellular communications system including at least two base stations using the same frequency (f₀), the mobile station comprising means for performing a method according to any one of claims 1-7.
